(19) United States
(12) Patent Application Publication
(10) Pub. No.: US 2011/0211438 A1
(43) Pub. Date: Sep. 1, 2011

(54) COLLIMATING LENS UNIT AND OPTICAL PICKUP DEVICE USING THE SAME

(75) Inventor: Takeshi SHIMANO, Ibaraki-shi (JP)

(73) Assignee: HITACHI MAXELL, LTD., OSAKA (JP)

(21) Appl. No.: 13/023,920

(22) Filed: Feb. 9, 2011

(30) Foreign Application Priority Data
Feb. 26, 2010 (JP) 2010-041494

(51) Int. Cl. G11B 7/135; G11B 7/00

(52) U.S. Cl. 369/112.05; 369/112.24; 369/112.06; 369/112.13; G9B/7.112; G9B/7

(57) ABSTRACT

An optical pickup device that can reduce interlayer crosstalk, without changing the configuration of the optical system, and without excessively increasing the size of the optical system. The optical pickup device reproduces a signal from a multilayered optical information recording medium having a plurality of information recording layers. The optical pickup device uses a collimating lens unit as a collimating optical system that collimates light from a light source, and the collimating lens unit includes a first and second lens group arranged at a predetermined distance from each other so as to form a converged light spot in the interior of the collimating lens unit, and an optical element provided between the first lens group and the second lens group so as to form a light spot at a position defocused from the position of the converged light spot, thereby decreasing quantity of light passing through the collimating lens unit.

### BACKGROUND

Aspects of the disclosure relate to a collimating lens unit as a collimating optical system used for an optical pickup device that reproduces a signal from an optical information recording medium. More specifically, to a collimating lens unit used for an optical pickup device that reproduces a signal from a multilayered optical information recording medium having a plurality of information recording layers. Furthermore, the present disclosure relates to an optical pickup device using the collimating lens unit.

Consumer use in the fields of music and video of optical information recording media represented by an optical disc started with CD (Compact Disc), and the capacity has been increased with the appearance of DVD (Digital Versatile Disc) and further BD (Blu-ray Disc). For BD, there are two media standards—single layer discs and two layer discs, and a two-layered disc has a memory capacity of about 50 GB. This corresponds to a capacity of recording, in an uncompressed manner, a digital high-definition TV animation for 4 hours. Meanwhile, for personal computer application, memory type optical discs such as CD-R (Recordable), DVD-RAM (Random Access Memory), and BD-R have been used for a hard disc backup. However, the capacity of optical discs cannot keep up with the increases in capacity of hard discs, and thus further multilayering of BD is required.

However, in using a multilayered disc, a part of a laser beam converged on an information recording layer that is to be reproduced is reflected during passing through a front-adjacent information recording layer (information recording layer closer to an objective lens). In another case, a part of the laser beam converged on the information recording layer that is to be reproduced, specifically, a laser beam that passes through with transmissivity for reproducing a back-adjacent information recording layer (information recording layer further from the objective lens) is reflected on the back information recording layer. Such laser beams inevitably will be mixed forming noise in the reproduction light. Such mixed noise is called “interlayer crosstalk.” The affect of interlayer crosstalk is more prevalent when the space between adjacent information recording layers is small, and thus the problem will be more severe as the number of the information recording layers is increased to achieve increases in the capacity. Therefore, when increasing the capacity through multilayering, the reduction of interlayer crosstalk is desired.

For this purpose, it has been suggested that a reflection surface is formed at the focal position of a reflected light condensing lens arranged in the detection optical system, and that an optical member is arranged to include the optical axis between the reflected light condensing lens and the reflection surface in order to dampen the quantity of reflected light (stray light) from adjacent information recording layers other than the information recording layer that is to be reproduced, or in order to change the direction of the reflected light (stray light) (see JP 2009-04691 A for example).

### SUMMARY

However, in the configuration disclosed in JP 2009-104691 A, the reflection surface is provided at a position that is provided with a photodetector of a conventional optical pickup device. Therefore, a quarter-wave plate is arranged between the reflection surface and a polarizing prism so that reflected light from the reflection surface reenters the polarizing prism, which obtains detection light for a detection optical system by splitting light on an optical path traveling from a semiconductor laser to a multilayered disc, and that the reentering light passes through towards the opposite side of the polarizing prism. Further, a condensing lens is used to converge the light that has passed through the polarizing prism on the photodetector. Namely, in the configuration as disclosed in JP 2009-104691 A, the configuration of the optical system is changed considerably, resulting in an excessive increase in size of the entire optical system.

Aspects of the present disclosure provide an optical pickup device that can reduce interlayer crosstalk without changing the configuration of an optical system and without excessively increasing the size of the entire optical system, and also to provide a collimating lens unit as a collimating optical system used for the same.

A collimating lens unit according to the present disclosure may be a collimating lens unit configured to collimate light from a light source, in an optical pickup device that reproduces a signal from a multilayered optical information recording medium having a plurality of information recording layers. And the collimating lens unit includes: a first lens group and a second lens group arranged at a predetermined distance from each other so as to form a converged light spot in the interior of the collimating lens unit; and an optical element provided between the first lens group and the second lens group in which a light spot defocused at a position different from a position of the converged light spot decreases a quantity of light passing through the collimating lens unit. That is, in the optical element, a defocused light spot is formed at a position different from a position of the converged light spot so as to decrease a quantity of light passing through the collimating lens unit. In other words, the optical element is provided between the first lens group and the second lens group so as to form a light spot at a position defocused from a position of the converged light spot, thereby decreasing a quantity of light passing through the collimating lens unit.

Here, the first and second lens groups each can be formed of a single lens or a plurality of lenses.

When the collimating lens unit of the present disclosure is used as a collimating optical system that collimates light from a light source, in an optical pickup device that reproduces a signal from a multilayered optical information recording medium having a plurality of information recording layers, it is possible to decrease a quantity of stray light that enters the collimating lens unit from the multilayered optical information recording medium side and that passes through the collimating lens unit. Therefore, interlayer crosstalk can be reduced. Because interlayer crosstalk can be reduced by employing the collimating lens unit of the present disclosure as the collimating optical system, which collimates light from a light source in an optical pickup device that reproduces a signal from a multilayered optical information recording medium having a plurality of information recording layers, it is not necessary to change the configuration of the optical system of the optical pickup device, thereby preventing an excessive increase in size of the entire optical system.

Further, the optical pickup device according to the present disclosure is an optical pickup device for reproducing a signal from a multilayered optical information recording medium having a plurality of information recording layers, and the collimating lens unit according to the present disclosure is used as a collimating optical system for collimating light from the light source.

In the optical pickup device of the present disclosure, because the above-mentioned collimating lens unit is used as a collimating optical system for collimating light from a light source, it is possible to provide an optical pickup device that can reduce interlayer crosstalk without changing the configuration of the optical system and without excessively increasing the size of the entire optical system.

### BRIEF DESCRIPTION OF THE DRAWINGS

FIG. 1 is a schematic view showing an optical pickup device according to a first exemplary embodiment;

FIG. 2 is an exploded perspective view showing an optical element that forms a collimating lens unit used for the optical pickup device according to the first exemplary embodiment;

FIG. 3 is a schematic view illustrating a function of the optical element that forms the collimating lens unit used for the optical pickup device according to the first exemplary embodiment;

FIG. 4 is a schematic view showing a specific example of a moving mechanism for a second lens group that forms the collimating lens unit used for the optical pickup device according to the first exemplary embodiment;

FIG. 5 is an optical path diagram for a case of BD configuration according to a numerical example 1;

FIG. 6 is a diagram showing a wave aberration due to the optical system of the optical pickup device according to the numerical example 1;

FIG. 7 is a graph showing a fluctuation in the interlayer crosstalk generated in a case where a slit of the collimating lens unit is shifted in an optical axis direction in the optical pickup device of the numerical example 1;

FIG. 8 is a schematic view showing an optical pickup device according to a second exemplary embodiment;

FIG. 9 is an exploded perspective view showing an optical element that forms a collimating lens unit used for the optical pickup device according to the second exemplary embodiment;

FIG. 10 is a schematic view illustrating a function of the optical element that forms the collimating lens unit used for the optical pickup device according to the second exemplary embodiment; and

FIG. 11 is a graph showing a fluctuation in interlayer crosstalk generated in a case where a pinhole in the collimating lens unit is shifted in a direction orthogonal to the optical axis direction in the optical pickup device of a numerical example 2.

### DETAILED DESCRIPTION OF EMBODIMENTS

In the collimating lens unit mentioned above, the first and second lens groups and the optical element are, for example, housed in a lens barrel.

Further, in the collimating lens unit, the optical element may include a diffracting/scattering surface formed in a plane parallel to an optical axis and having a slit orthogonal to the optical axis, and that the collimating lens unit transmits light that enters the slit, while diffracting or scattering light that enters the diffracting/scattering surface except the slit. For example, when using the collimating lens unit as a collimating optical system of an optical pickup device, it is possible to reduce interlayer crosstalk by diffracting or scattering stray light that has entered the collimating lens unit from the multilayered optical information recording medium side with the diffracting/scattering surface except the slit.

Additionally, the optical element may include an optical absorption surface formed in a plane parallel to an optical axis and having a slit that extends orthogonal to the optical axis, and that the collimating lens unit transmits light that enters the slit, while absorbing light that enters the optical absorption surface except the slit. For example, when using the collimating lens unit as a collimating optical system of an optical pickup device, it is possible to reduce the interlayer crosstalk by absorbing stray light that has entered the collimating lens unit from the multilayered optical information recording medium side with the optical absorption surface except the slit.

Moreover, the optical element may include a pinhole formed on a surface perpendicular to the optical axis, and that the collimating lens unit transmits light that enters the pinhole, while shielding light that enters the surface except the pinhole. For example, when using the collimating lens unit as a collimating optical system of an optical pickup device, it is possible to reduce the interlayer crosstalk by shielding stray light that has entered the collimating lens unit from the multilayered optical information recording medium side with a surface except the pinhole.

Further, at least one of the first lens group and the second lens group may be movable in the optical axis direction. For example, it is possible to correct a spherical aberration by moving at least one of the first lens group and the second lens group so as to adjust the distance between the first lens group and the second lens group. In such a case, when the collimating lens unit is used as the collimating optical system of the optical pickup device, any of the first lens group and the second lens group positioned closer to the objective lens of the optical pickup device may be movable in the optical axis direction.

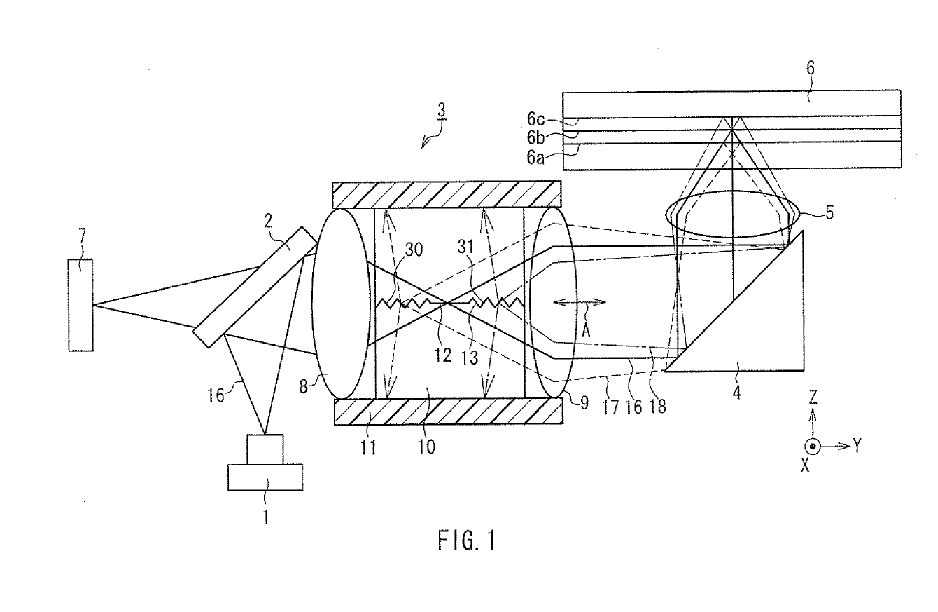

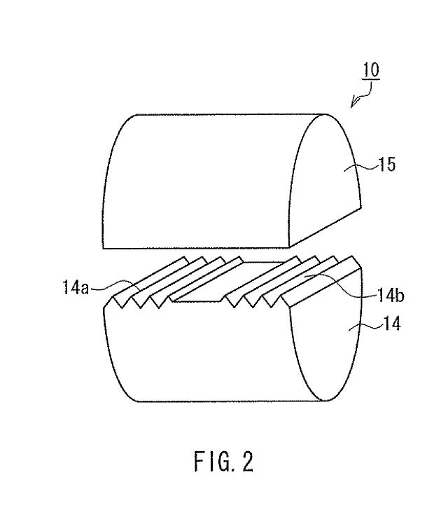

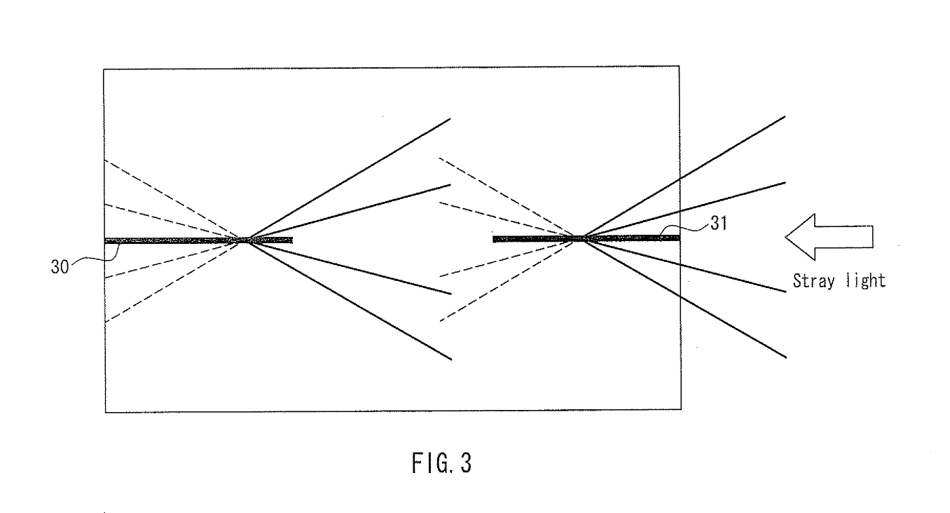

FIG. 1 is a schematic view showing an optical pickup device according to a first exemplary embodiment. FIG. 2 is an exploded perspective view showing an optical element that forms a collimating lens unit used for the optical pickup device. FIG. 3 is a schematic view illustrating a function of the optical element. Here, the XYZ three-dimensional rectangular coordinate system is set as shown in FIG. 1.

As shown in FIG. 1, an optical system of the optical pickup device in the first exemplary embodiment includes: a half mirror 2 that bends the optical path of light emitted from a light source 1 in a Z-axis direction, to a Y-axis direction; a collimating lens unit 3 as a collimating optical system that collimates light from the light source 1; a reflecting mirror 4 that bends the optical path of light from the collimating lens unit 3, to the Z-axis direction; and an objective lens 5 that converges the light bent in the Z-axis direction, on an arbitrary information recording layer of a multilayered optical information recording medium 6. The components are arranged in the optical path in this order from the light source 1 to the multilayered optical information recording medium 6. A photodetector 7 is arranged on the side opposite to the collimating lens unit 3 in the lateral direction, across the half mirror 2.

Here, for the multilayered optical information recording medium 6, a multilayered BD having three information recording layers 6a, 6b and 6c is used. For the light source 1, a semiconductor laser that emits a violet light having a central wavelength of 405 nm is used.

The collimating lens unit 3 includes a first lens group 8 and a second lens group 9 arranged at a predetermined distance from each other so as to form a converged light spot in the interior of the collimating lens unit 3, and an optical element 10 that is provided between the first lens group 8 and the second lens group 9 and that forms a light spot at a position defocused from the position of the converged light spot so as to decrease the quantity of light passing through the collimating lens unit 3. The first lens group 8, the second lens group 9 and the optical element 10 are housed in a lens barrel 11.

By using the collimating lens unit 3 as a collimating optical system in an optical pickup device that reproduces a signal from the multilayered optical information recording medium 6, the quantity of stray light that enters the collimating lens unit 3 from the multilayered optical information recording medium 6 side and passes through the collimating lens unit 3 can be decreased, so that the interlayer crosstalk can be reduced. Because the interlayer crosstalk can be reduced by using the collimating lens unit 3 as a collimating optical system for an optical pickup device that reproduces a signal from the multilayered optical information recording medium 6, it is not necessary to change the configuration of the optical system of the optical pickup device, and furthermore, the size of the entire optical system will not be excessively increased.

The optical element 10 includes a diffracting/scattering surface 13 that is formed in a plane parallel to an optical axis and that has a slit 12 that extends orthogonal to the optical axis. Further, the collimating lens unit 3 including the optical element 10 has a function of transmitting light that enters the slit 12 while diffracting or scattering light that enters the diffracting/scattering surface 13 except the slit 12.

More specifically, as shown in FIG. 2, the optical element 10 is composed of a pair of semi-columnar transparent members 14, 15. The pair of transparent members 14, 15 are joined to form a column. On the joint surface of the transparent member 14, triangular wave gratings 14a, 14b are formed on the both end parts, and the area between the grating 14a and the grating 14b is flat. The joint surface of the transparent member 15 is made flat as a whole. After forming a deposition film of chromium or nickel in the regions of gratings 14a, 14b formed on the joint surface of the transparent member 14, the joint surface of the transparent member 15 is disposed on the joint surface of the transparent member 14, and the gap between the joint surfaces is filled with an adhesive having a refractive index equal to that of the transparent members 14, 15. Thereby, an optical element 10 having grating parts 30, 31 is obtained (see FIG. 1), the joint surfaces after joining the transparent members 14, 15 makes the diffracting/scattering surface 13, and the flat part makes the slit 12. Here, a pair of semi-columnar transparent members 14, 15 are used and these transparent members 14, 15 are joined to each other to form a column. However, the configuration is not limited to this example. For example, it is also possible to use a pair of prismatic transparent members, which are joined to each other to form a prism.

By configuring the collimating lens unit 3 as described above, when the collimating lens unit 3 is used as a collimating optical system of an optical pickup device, stray light entering from the multilayered, optical information recording medium 6 side to the collimating lens unit 3 is diffracted by either the grating part 30 or 31 so as to reduce the interlayer crosstalk as shown in FIG. 3.

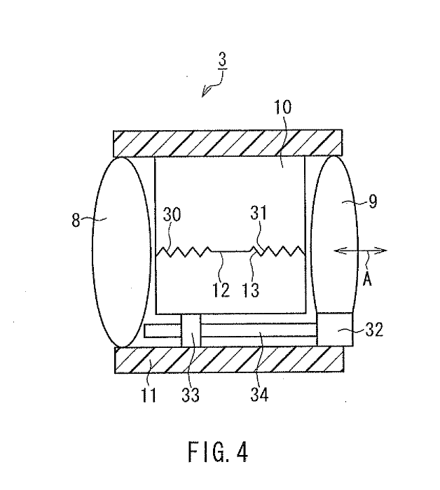

Further, at least one of the first lens group 8 and the second lens group 9 may be movable in the optical axis direction. Accordingly, at least one of the first lens group 8 and the second lens group 9 is moved in the optical axis direction so as to adjust the distance between the first lens group 8 and the second lens group 9, and thus the spherical aberration can be corrected. In the first exemplary embodiment, the second lens group 9 is provided to be movable inside the lens barrel 11 in the optical axis direction (see an arrow-A in FIG. 1). The moving mechanism of the second lens group 9 is configured to include a worm gear, a motor or the like (not shown). Alternatively, the moving mechanism of the second lens group 9 can be configured to include a piezoelectric element. The specific configuration is shown in FIG. 4. As shown in FIG. 4, the second lens group 9 is provided movably in the optical axis direction within the lens barrel 11 via a lens holder 32. A supporter 33 is interposed between the optical element 10 and the inner face of lens barrel 11. The piezoelectric element 34 is fixed to the lens holder 32 at one end, and to the supporter 33 at the other end. Namely, the piezoelectric element 34 is arranged in the optical axis direction in a state fixed at one end to the lens holder 32 and at the other end to the supporter 33. By employing such a configuration, and by varying the voltage to be applied to the piezoelectric element 34, it is possible to move the second lens group 9 in the optical axis direction (the direction of the arrow-A in FIG. 4) so as to adjust the distance between the first lens group 8 and the second lens group 9.

A reproduction operation on the multilayered optical information recording medium in the first exemplary embodiment will be described below.

A laser beam 16 (solid line) emitted in the Z-axis direction from a semiconductor laser as the light source 1 is reflected by the half mirror 2 so that the optical path is bent in the Y-axis direction, and subsequently enters the collimating lens unit 3. The laser beam 16 that has entered the collimating lens unit 3 is converged by the first lens group 8, enters the slit 12 in the optical element 10, and then is collimated by the second lens group 9. The optical path of the collimated laser beam 16 is bent in the Z-axis direction by the reflecting mirror 4. The laser beam 16 with the optical path bent in the Z-axis direction is converged for example on the second information recording layer 6b of the multilayered BD as the multilayered optical information recording medium 6 by the objective lens 5.

The laser beam 16 (reproduction light) reflected by the second information recording layer 6b passes the objective lens 5 and the reflecting mirror 4 in this order, and then enters the collimating lens unit 3. The laser beam 16 that has entered the collimating lens unit 3 is converged by the second lens group 9, enters the slit 12 in the optical element 10, and then passes through the first lens group 8, and further passes through the half mirror 2 so as to be detected by the photodetector 7. As a result of the series of actions, a signal from the multilayered optical information recording medium 6 is reproduced.

Reflected light is generated also by a front-adjacent first information recording layer 6a (information recording layer closer to the objective lens 5) and a back-adjacent third information recording layer 6c (information recording layer further from the objective lens 5), and the reflected light generated by the front-adjacent first information recording layer 6a and the back-adjacent third information recording layer 6c forms stray light, which causes interlayer crosstalk.

A laser beam 17 (undesired reflected light indicated with a broken line) reflected by the front-adjacent first information recording layer 6a (information recording layer closer to the objective lens 5) passes the objective lens 5 and the reflecting mirror 4 in this order and then enters the collimating lens unit 3. The laser beam 17 that has entered the collimating lens unit 3 is converged by the second lens group 9, and forms a converged light spot on the grating part 30 situated closer to the first lens group 8. In this manner, it is possible to diffract the laser beam 17 (undesired reflected light) by the grating part 30 closer to the first lens group 8, thereby decreasing the quantity of laser beam 17 passing through the first lens group 8 and detected by the photodetector 7, and thus the interlayer crosstalk can be reduced.

Another laser beam 18 (undesired reflected light indicated with an alternate long-and-short dashed line) reflected by the back-adjacent third information recording layer 6c (information recording layer further from the objective lens 5) passes the objective lens 5 and the reflecting mirror 4 in this order and then enters the collimating lens unit 3. The laser beam 18 that has entered the collimating lens unit 3 is converged by the second lens group 9 and forms a converged light spot on the grating part 31 situated closer to the second lens group 9. In this manner, it is possible to diffract the laser beam 18 (undesired reflected light) by the grating part 31 closer to the second lens group 9, thereby decreasing the quantity of laser beam 18 passing through the first lens group 8 and detected by the photodetector 7, and thus the interlayer crosstalk can be reduced.

The interlayer crosstalk can be reduced further by adhering an optical absorption member having microscopic asperities of a pitch smaller than the wavelength of the laser beam in use on the inner face of the lens barrel 11 so that the light diffracted by the grating part 30 or the grating part 31 will be absorbed by the optical absorption member.

### Numerical Example 1

Hereinafter, an exemplary design of an optical pickup device will be described in detail with reference to a numerical example.

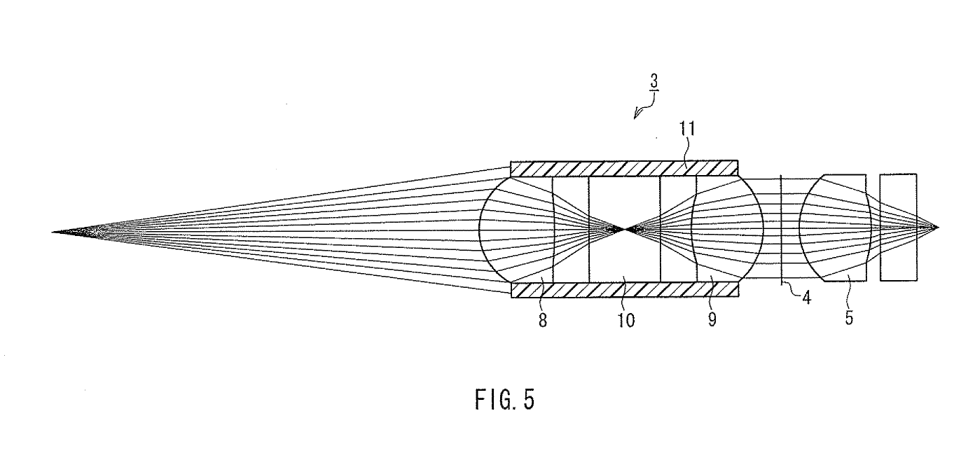

FIG. 5 shows optical paths for the case of BD configuration. Table 1 below shows basic data for optical systems of the present numerical example.

TABLE 1

| | | Distance | | | |
|---|---|---|---|---|---|
| | Radius of | between | | Aper- | |
| Surface | curvature | adjacent | Glass | ture | Conic |
| number | (mm) | surfaces (mm) | material | (mm) | constant |
| OBJ | ∞ | 12 | — | 0 | 0 |
| 1 | 1.297251 | 2 | BK7 | 3 | −0.657533 |
| 2 | −127.7284 | 1.1 | — | 3 | −2845.762 |
| 3 | ∞ | 2 | BK7 | 3 | 0 |
| 4 | ∞ | 0.9 | — | 3 | 0 |
| 5 | 2.442279 | 2 | BK7 | 3 | −8.739228 |
| 6 | −1.936003 | 0.5 | — | 3 | −0.148984 |
| 7 | ∞ | 0.5 | — | 3 | 0 |
| 8 | 1.936003 | 2 | BK7 | 3 | −0.148984 |
| 9 | −2.441179 | 0.3 | — | 3 | −8.739228 |
| 10 | ∞ | 1 | BK7 | 3 | 0 |
| 11 | ∞ | 0.6 | — | 3 | 0 |
| IMA | ∞ | — | — | — | 0 |

In the above Table 1, “OBJ” denotes a position of the light source 1, the surface number 1 denotes a lens surface of the first lens group 8 closer to the light source 1, the surface number 2 denotes a lens surface of the first lens group 8 closer to the multilayered optical information recording medium 6, the surface number 3 denotes a surface of the optical element 10 closer to the light source 1, the surface number 4 denotes a surface of the optical element 10 closer to the multilayered optical information recording medium 6, the surface number 5 denotes a lens surface of the second lens group 9 closer to the light source 1, the surface number 6 denotes a lens surface of the second lens group 9 closer to the multilayered optical information recording medium 6, the surface number 7 denotes a mirror surface of the reflecting mirror 4, the surface number 8 denotes a lens surface of the objective lens 5 closer to the light source 1, the surface number 9 denotes a lens surface of the objective lens 5 closer to the multilayered optical information recording medium 6, the surface number 10 denotes a surface of a transparent substrate of the multilayered optical information recording medium 6 closer to the light source 1, the surface number 11 denotes a surface of the transparent substrate of the multilayered optical information recording medium 6 closer to the information recording layers, and “IMA” denotes a position of the second information recording layer 6b, respectively.

The surfaces indicated with the surface numbers 1, 2, 5, 6, 7, 8 and 9 in the above Table 1 are aspheric surfaces expressed by Equation 1 below, the aspherical coefficients are indicated by the following Table 2.

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad [ Equation 1 ]$$

In the above Equation 1, z denotes the amount of sag, r denotes a pupil inplane radius coordinate, c denotes a curvature, k denotes a conic constant, and αₙ denotes an aspherical coefficient, respectively.

TABLE 2

| Surface number | 1 | 2 | 5 | 6 | 7 | 8 | 9 |
|---|---|---|---|---|---|---|---|
| α₁ | 0 | 0 | 0 | 0 | 0 | 0 | 0 |
| α₂ | −0.002022 | 0.003271 | −0.05025 | 0.00148 | −0.00148 | −0.00148 | 0.05025 |
| α₃ | 3.4e−005 | −0.000157 | 0.00712 | −0.001112 | 0.001112 | 0.001112 | −0.00712 |
| α₄ | 0 | 0 | 0 | 0 | 0 | 0 | 0 |
| α₅ | 0 | 0 | 0 | 0 | 0 | 0 | 0 |
| α₆ | 0 | 0 | 0 | 0 | 0 | 0 | 0 |
| α₇ | 0 | 0 | 0 | 0 | 0 | 0 | 0 |
| α₈ | 0 | 0 | 0 | 0 | 0 | 0 | 0 |

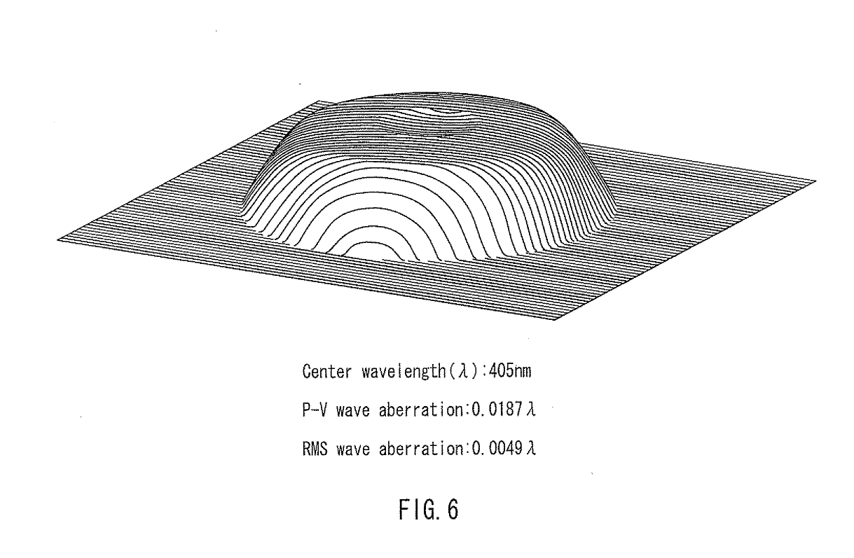

FIG. 6 shows a wave aberration due to the optical system of the optical pickup device in the present numerical example. This diagram showing the aberration refers to a laser beam having a central wavelength (λ) of 405 nm. The P-V (Peak to Valley) wave aberration is 0.0187λ, and the RMS (Root Mean Square) wave aberration is 0.0049λ. Since the P-V wave aberration does not exceed the Rayleigh limit (λ/4) and the RMS wave aberration does not exceed the Marechal limit (0.07λ), it is indicated that the wave aberration is favorably corrected.

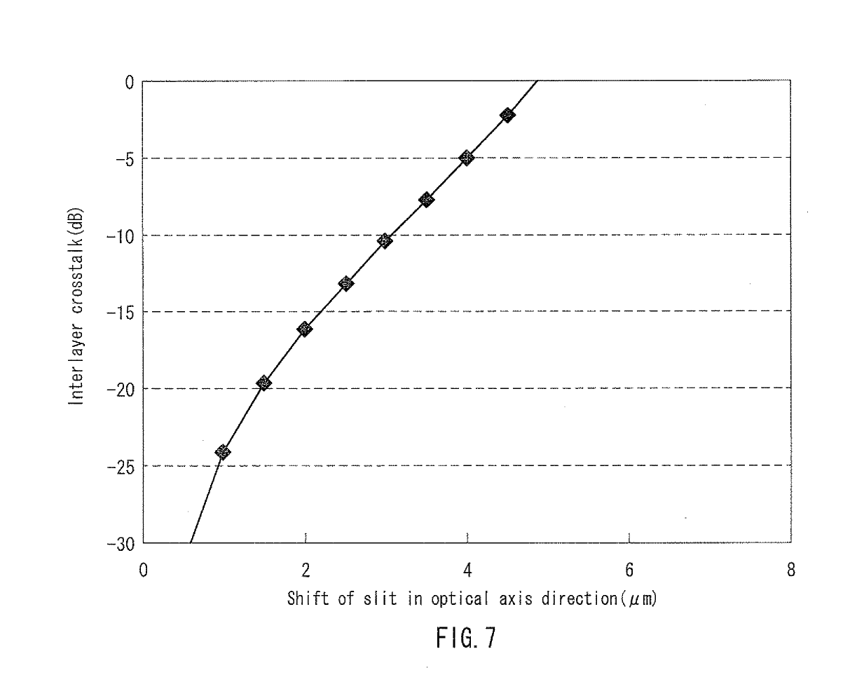

FIG. 7 shows a fluctuation in the interlayer crosstalk generated in a case where the slit 12 of the collimating lens unit 3 is shifted in the optical axis direction (Y-axis direction in FIG. 1) in the optical pickup device of the present numerical example. Here, the numerical aperture (NA) of the objective lens 5 is 0.85, the internal numerical aperture (NA) of the collimating lens unit 3 is 0.5, the width in the Y-axis direction of the slit 12 is 30 μm. In the multilayered optical information recording medium 6, both the separation between the first information recording layer 6a and the second information recording layer 6b, and the separation between the second information recording layer 6b and the third information recording layer 6c are 10 μm. And, the interlayer refractive index is 1.62.

As shown in FIG. 7, if the slit 12 can be formed without a shift in the optical axis direction (Y-axis direction), the generated interlayer crosstalk can be infinitesimal. Further, even if the position of the slit 12 is shifted by approximately 4 μm in the optical axis direction due to a processing error, the interlayer crosstalk can be kept within a tolerance, and thus it is possible to provide a practical collimating lens unit.

In the first exemplary embodiment, the first lens group 8 and the second lens group 9 are each composed of a single lens. Alternatively, at least one of the first and second lens groups may be composed of a plurality of lenses.

In the first exemplary embodiment, the diffracting/scattering surface 13 except the slit 12 is formed of a triangular wave grating part. Alternatively, the light-scattering surface except the slit 12 may be formed of a rectangular wave grating part.

In the first exemplary embodiment, the diffracting/scattering surface 13 except the slit 12 is formed of the grating part 30 and the grating part 31. However, the diffracting/scattering surface except the slit 12 is not necessarily formed of such grating parts. Alternatively, for example, it is possible to form the diffracting/scattering surface except the slit 12 with particles aligned at regular intervals so as to scatter light entering the diffracting/scattering surface. Additionally, it is possible to apply a black coating material to the region except the slit 12 so as to form an optical absorption surface, so that the light entering the optical absorption surface will be absorbed. There is no particular limitation as long as the parts except the slit 12 have a function of forming a light spot at a position defocused from the position of the converged light spot of the reproduction light and decreasing quantity of light passing through the collimating lens unit 3.

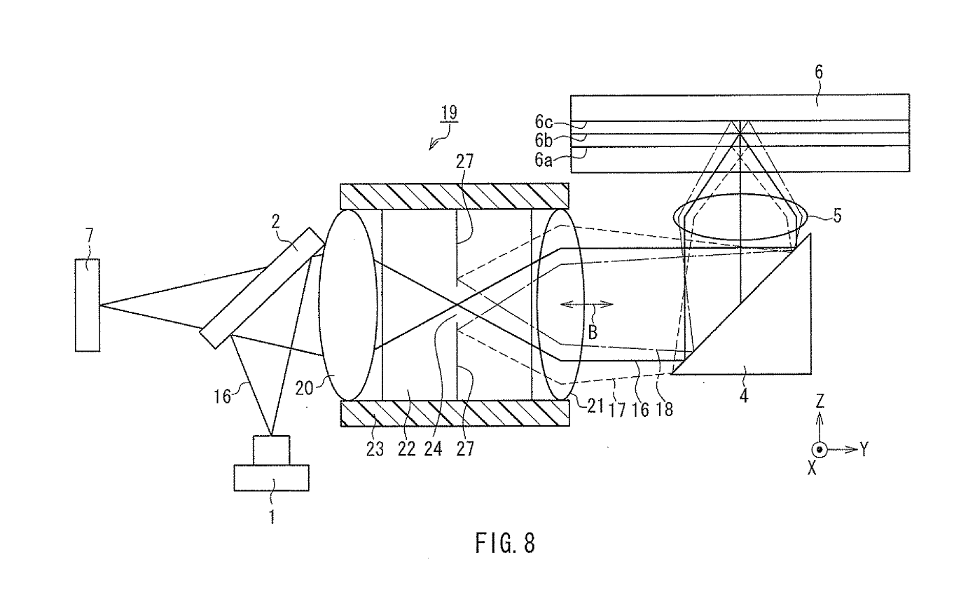

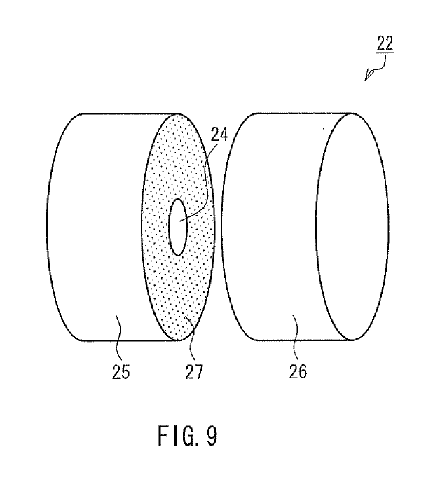

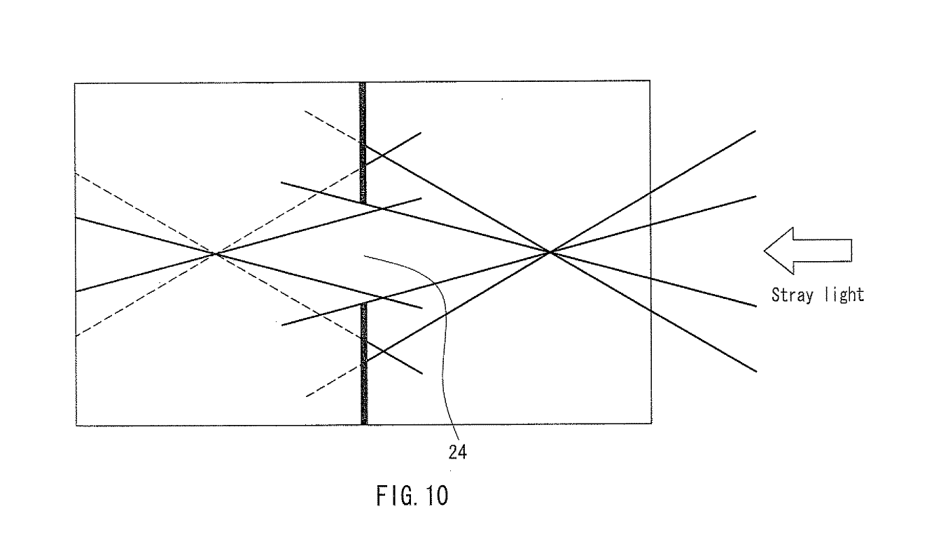

FIG. 8 is a schematic view showing an optical pickup device according to a second exemplary embodiment. FIG. 9 is an exploded perspective view showing an optical element that forms a collimating lens unit used for the optical pickup device. FIG. 10 is a schematic view illustrating the function of the optical element. Here, the XYZ three-dimensional rectangular coordinate system is set as shown in FIG. 8. Since the optical pickup device of the second exemplary embodiment is configured similarly to the optical pickup device of the first exemplary embodiment except for the configuration of the collimating lens unit, components that are the same as those in FIG. 1 are denoted by the same reference numerals, and the description thereof has been omitted.

As shown in FIG. 8, the collimating lens unit 19 includes a first lens group 20 and a second lens group 21 arranged at a predetermined distance from each other so as to form a converged light spot in the interior of the collimating lens unit 19, and an optical element 22 that is provided between the first lens group 20 and the second lens group 21 and that forms a light spot at a position defocused from the position of the converged light spot so as to decrease the quantity of light passing through the collimating lens unit 19. The first lens group 20, the second lens group 21 and the optical element 22 are housed in a lens barrel 23.

The optical element 22 includes a pinhole 24 formed on a surface perpendicular to the optical axis. And the collimating lens unit 19 provided with the optical element 22 has a function of transmitting light that enters the pinhole 24 and shielding light that enters the surface except the pinhole 24.

More specifically, as shown in FIG. 9, the optical element 22 is composed of a pair of columnar transparent members 25, 26 that are joined to each other on the end faces. On the joint surface of the transparent member 25, a light-shielding film of aluminum or the like is formed except the center (circle) so that light will pass only the center. Similarly, on the joint surface of the transparent member 26, a light-shielding film is formed except the center (circle) so that light will pass only through the center. Therefore, the center of the joint surfaces after joining the transparent members 25, 26 forms the pinhole 24, and the parts except the pinhole 24 form a light-shielding surface 27. The light-shielding film may be formed on at least one of the joint surface of the transparent member 25 and the joint surface of the transparent member 26. Here, a pair of columnar transparent members 25, 26 are used and the end faces of these transparent members 25, 26 are joined to each other. However, the second exemplary embodiment is not limited to this configuration. For example, it is also possible to use a pair of prismatic transparent members and join the end faces of the pair of transparent members.

By configuring the collimating lens unit 19 as described above, when the collimating lens unit 19 is used as a collimating optical system of an optical pickup device, the interlayer crosstalk can be reduced by shielding stray light that enters from the multilayered optical information recording medium 6 side to the collimating lens unit 19, with the light-shielding surface 27 except the pinhole 24 as shown in FIG. 10.

Further, at least one of the first lens group 20 and the second lens group 21 may be movable in the optical axis direction. For example, the second lens group 21 is provided to be movable within the lens barrel 23 in the optical axis direction (see an arrow-B in FIG. 8). The moving mechanism of the second lens group 21 is configured to include a worm gear, a motor or the like (not shown). Alternatively, the moving mechanism of the second lens group 21 can be configured to include a piezoelectric element (see FIG. 4).

A reproduction operation on the multilayered optical information recording medium in the present embodiment will be described below.

A laser beam 16 (solid line) emitted in the Z-axis direction from a semiconductor laser as the light source 1 is reflected by the half mirror 2 so that the optical path is bent in the Y-axis direction, and subsequently enters the collimating lens unit 19. The laser beam 16 that has entered the collimating lens unit 19 is converged by the first lens group 20, enters the pinhole 24 in the optical element 22, and then is collimated by the second lens group 21. The optical path of the collimated laser beam 16 is bent in the Z-axis direction by the reflecting mirror 4. The laser beam 16 with the optical path bent in the Z-axis direction is converged for example on the second information recording layer 6b of the multilayered BD as the multilayered optical information recording medium 6 by the objective lens 5.

The laser beam 16 (reproduction light) reflected by the second information recording layer 6b passes the objective lens 5 and the reflecting mirror 4 in this order, and then enters the collimating lens unit 19. The laser beam 16 that has entered the collimating lens unit 19 is converged by the second lens group 21, enters the pinhole 24 in the optical element 22, and then passes through the first lens group 20, and further passes through the half mirror 2 so as to be detected by the photodetector 7. As a result of the series of actions, a signal from the multilayered optical information recording medium 6 is reproduced.

A laser beam 17 (undesired reflected light indicated with a broken line) reflected by a front-adjacent first information recording layer 6a (information recording layer closer to the objective lens 5) passes the objective lens 5 and the reflecting mirror 4 in this order and then enters the collimating lens unit 19. The laser beam 17 that has entered the collimating lens unit 19 is converged by the second lens group 21, and forms a light spot on the light-shielding surface 27 including the pinhole 24 so as to come into a focus between the pinhole 24 and the first lens group 20. In this manner, it is possible to shield a part of the laser beam 17 (undesired reflected light) by the light-shielding surface 27 surrounding the pinhole 24 so as to decrease the quantity of laser beam 17 passing through the first lens group 20 and detected by the photodetector 7, and thus the interlayer crosstalk can be reduced.

Another laser beam 18 (undesired reflected light indicated with an alternate long-and-short dashed line) reflected by a back-adjacent third information recording layer 6c (information recording layer further from the objective lens 5) passes the objective lens 5 and the reflecting mirror 4 in this order and then enters the collimating lens unit 19. The laser beam 18 that has entered the collimating lens unit 19 is converged by the second lens group 21 and forms a light spot on the light-shielding surface 27 including the pinhole 24 so as to come into a focus between the second lens group 21 and the pinhole 24. In this manner, it is possible to shield a part of the laser beam 18 (undesired reflected light) with the light-shielding surface 27 surrounding the pinhole 24, thereby decreasing the quantity of laser beam 18 passing through the first lens group 20 and detected by the photodetector 7, and thus the interlayer crosstalk can be reduced.

### Numerical Example 2

The basic data for the optical system in the numerical example for the optical pickup device according to the second exemplary embodiment, and the aspherical coefficients for respective lenses are the same as those indicated in the above Table 1 and Table 2 of the numerical example 1, and thus, the obtained aberration is the same as that indicated in FIG. 6 for the numerical example 1. Furthermore, the optical path diagram for the case of BD configuration is the same as that in FIG. 5 referring to the numerical example 1.

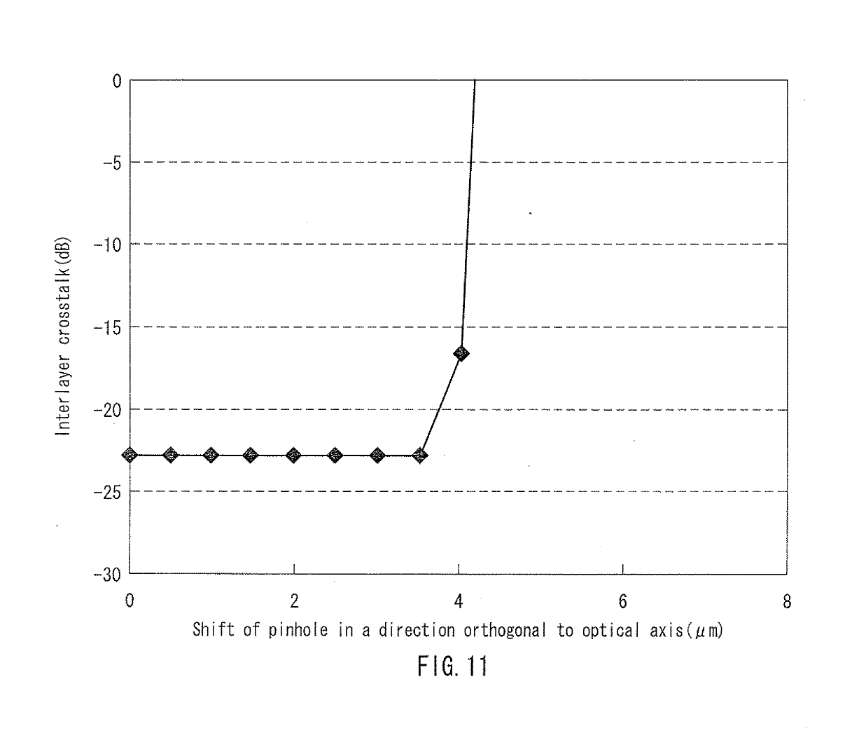

FIG. 11 shows a fluctuation in the interlayer crosstalk generated in a case where the pinhole 24 of the collimating lens unit 19 is shifted in a direction orthogonal to the optical axis direction (for example, X-axis direction or Z-axis direction in FIG. 8) in the optical pickup device of the present numerical example. Here, the numerical aperture (NA) of the objective lens 5 is 0.85, the internal numerical aperture (NA) of the collimating lens unit 19 is 0.5, the diameter of the pinhole 24 is 8 μm. In the multilayered optical information recording medium 6, both the separation between the first information recording layer 6a and the second information recording layer 6b, and the separation between the second information recording layer 6b and the third information recording layer 6c are 10 μm. Further, the interlayer refractive index is 1.62.

As shown in FIG. 11, if the pinhole 24 can be formed without a shift in the direction orthogonal to the optical axis direction (for example, the X-axis direction or the Z-axis direction), the generated interlayer crosstalk can be kept within a tolerance. Similarly, even if the position of the pinhole 24 is shifted by approximately 4 μm in the direction orthogonal to the optical axis direction due to a processing error, the interlayer crosstalk can be kept within a tolerance, and thus it is possible to provide a practical collimating lens unit.

In the second exemplary embodiment, the first lens group 20 and the second lens group 21 are each composed of a single lens. Alternatively, at least one of the first and second lens groups may be composed of a plurality of lenses.

In the collimating lens unit of the disclosure, it is possible to decrease quantity of light passing through the collimating lens unit by forming a light spot at a position defocused from the position of converged spot of light that has entered the collimating lens unit. Therefore, the collimating lens unit of the disclosure can be used as a collimating optical system of an optical pickup device for a multilayered optical information recording medium where reduction of interlayer crosstalk is desired.

The collimating lens unit of the disclosure may be embodied in other forms without departing from the spirit or essential characteristics thereof. The embodiments disclosed in this application are to be considered in all respects as illustrative and not limiting. The scope of the disclosure is indicated by the appended claims rather than by the foregoing description, and all changes which come within the meaning and range of equivalency of the claims are intended to be embraced therein.

What is claimed is:

1. A collimating lens unit as a collimating optical system that collimates light from a light source, in an optical pickup device that reproduces a signal from a multilayered optical information recording medium having a plurality of information recording layers, the collimating lens unit comprising:
a first lens group and a second lens group arranged at a predetermined distance from each other so as to form a converged light spot in an interior of the collimating lens unit; and
an optical element provided between the first lens group and the second lens group in which a light spot defocused at a position different from a position of the converged light spot decreases a quantity of light passing through the collimating lens unit.

2. The collimating lens unit according to claim 1, wherein the first lens group, the second lens group and the optical element are housed in a lens barrel.

3. The collimating lens unit according to claim 1, wherein the optical element comprises a diffracting/scattering surface formed in a plane parallel to an optical axis and having a slit that extends orthogonal to the optical axis, and
the collimating lens unit transmits light that is incident on the slit, while diffracting or scattering light that is incident on the diffracting/scattering surface.

4. The collimating lens unit according to claim 1, wherein the optical element comprises an optical absorption surface formed in a plane parallel to an optical axis and having a slit that extends orthogonal to the optical axis, and
the collimating lens unit transmits light that is incident on the slit, while absorbing light that is incident on the optical absorption surface.

5. The collimating lens unit according to claim 1, wherein the optical element comprises a pinhole formed in a surface perpendicular to the optical axis, and
the collimating lens unit transmits light that is incident on the pinhole, while shielding light that is incident on the surface.

6. The collimating lens unit according to claim 1, wherein at least one of the first lens group and the second lens group is movable along a direction of an optical axis.

7. The collimating lens unit according to claim 6, wherein in a case of using the collimating lens unit as the collimating optical system of the optical pickup device, any of the first lens group and the second lens group positioned closer to an objective lens of the optical pickup device is movable in the optical axis direction.

8. An optical pickup device for reproducing a signal from a multilayered optical information recording medium having a plurality of information recording layers,
wherein the collimating lens unit according to claim 1 is used as a collimating optical system for collimating light from the light source.

9. The collimating lens unit according to claim 3, wherein the optical element further comprises a pair of semi-columnar transparent members, wherein
the diffracting/scattering surface and the slit are formed on one of the pair of semi-columnar transparent members,
the diffracting/scattering surface includes a first portion and a second portion, and
the slit is disposed along the optical axis between the first and second portions of the diffracting/scattering surface.

10. The collimating lens unit according to claim 6, wherein the collimating lens unit further comprises:
a lens holder that supports at least one of the first lens group and the second lens group,
a support member, and
a piezoelectric element disposed between the lens holder and the support member and configured to move the lens holder in the optical axis direction based on a voltage applied to the piezoelectric element.

11. The collimating lens unit according to claim 5, wherein
the optical element further comprises:
a pair of columnar transparent members, and
a light-shielding film that is formed on a surface of one of the pair of columnar transparent members, the surface being perpendicular to the optical axis, and
the pinhole is formed through the light-shielding film about the optical axis.

12. The collimating lens unit according to claim 3, wherein the diffracting/scattering surface is formed of triangular wave grating.

13. The collimating lens unit according to claim 3, wherein the diffracting/scattering surface is formed of rectangular wave grating.

14. The collimating lens unit according to claim 3, wherein the diffracting/scattering surface is formed of a plurality of particles that are aligned at regular intervals so as to diffract or scatter the light that is incident on the diffracting/scattering surface.

15. A collimating lens unit comprising:
a first lens group and a second lens group arranged along an optical axis; and
an optical element located along the optical axis between the first lens group and the second lens group, the optical element including a first portion and a second portion, wherein
the collimating lens unit transmits light incident on the first portion, while diffracting or scattering light incident on the second portion so as to decrease an amount of light passing through the collimating lens unit.
